(19) United States
(12) Patent Application Publication
(10) Pub. No.: US 2020/0190326 A1
(43) Pub. Date: Jun. 18, 2020

(54) PROCESS FOR PRODUCING A POLYDIENE-POLYAMIDE BLOCK THERMOPLASTIC ELASTOMER COPOLYMER OF COMB STRUCTURE

(71) Applicant: COMPAGNIE GENERALE DES ETABLISSEMENTS MICHELIN, Clemont-Ferrand (FR)

(72) Inventors: Nathalie COSTE, Clermont-Ferrand Cedex 9 (FR); Séverin DRONET, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/472,499

(22) PCT Filed: Dec. 21, 2017
(86) PCT No.: PCT/FR2017/053762

§ 371 Date: Jun. 21, 2019

(30) Foreign Application Priority Data
Dec. 21, 2016 (FR) 1663071

(51) Int. Cl. C08L 87/00; C08G 81/02; B60C 1/00

(52) U.S. Cl. CPC C08L 87/005; C08L 2207/04; B60C 1/0016; C08G 81/028

(57) ABSTRACT

A process for the preparation of a polydiene/polyamide block thermoplastic elastomer (TPE) copolymer of comb structure is provided. The percentage by weight of polyamide of the copolymer is between 10% and 35% by weight, with respect to the weight of the copolymer. The polyamide and a diene elastomer functionalized by at least one pendant epoxide functional group along the main chain are introduced into an extruder.

A polydiene/polyamide block thermoplastic elastomer (TPE) copolymer of comb structure is also provided. The copolymer comprises units bearing a pendant polyamide along the chain which is bonded to the latter via a group resulting from the reaction, with an epoxide functional group, of an amine or acid functional group of the polyamide. A rubber composition comprising the copolymer, and a tire comprising the rubber composition is also provided.

This application is a 371 national phase entry of PCT/FR2017/053762 filed on 21 Dec. 2017, which claims benefit of French Patent Application No. 1663071, filed 21 Dec. 2016, the entire contents of which are incorporated herein by reference for all purposes.

### BACKGROUND

### 1. Technical Field

The field of the present invention is that of compositions of diene thermoplastic elastomer (TPE) copolymer comprising polyamides along its main chain. The present invention also relates to a process for the preparation of a polydiene thermoplastic elastomer copolymer comprising polyamides along its main chain and thus exhibiting improved mechanical and hysteresis properties. It more particularly relates to the rubber compositions, tyres and tyre treads having a low rolling resistance comprising this thermoplastic elastomer.

### 2. Related Art

Materials having thermoplastic elastomer (TPE) properties combine the elastic properties of the elastomers and the thermoplastic nature, namely the ability to reversibly soften and harden under the action of heat, of the pendant blocks.

In the context of the invention, a material having thermoplastic elastomer properties is desired, based mainly on polyamide, offering novel properties. Also desired is a material which can be manufactured by a process which is continuous, flexible, low-cost and adaptable to thermoplastic elastomers, thus polymers having high glass-transition temperature or melting points, if appropriate.

Thermoplastic elastomers comprising polyamides at the chain end are known. However, these copolymers are not satisfactory as they contain too little polyamide and their properties are different as a result of the location at the chain end of the polyamide. Furthermore, as a result of the solvent incompatibility between the elastomers and the polyamide, it is difficult to find a solvent common to these two compounds, which increases the difficulty of developing a process of synthesis.

Thus, it has become necessary to provide novel processes for the synthesis of thermoplastic elastomer (TPE) in order to overcome the disadvantages of the known materials and processes and to make possible significant grafting, indeed even quantitative grafting, of the polyamides along the main chain.

### SUMMARY

It is an object of the present invention to overcome these disadvantages by providing a process for the synthesis of a thermoplastic elastomer comprising polyamides along its main chain, the percentage by weight of polyamide of which is between 10% and 35% by weight, and thus exhibiting improved mechanical and hysteresis properties.

The process according to the invention is a process for the preparation of a polydiene/polyamide block thermoplastic elastomer (TPE) copolymer of comb structure, the percentage by weight of polyamide of which is between 10% and 35% by weight, with respect to the weight of the copolymer, comprising the reaction, in an extruder, of a polyamide and of a diene elastomer functionalized by at least one pendant epoxide functional group along the main chain. In particular, polyamide and diene elastomer functionalized by at least one pendant epoxide functional group along the main chain are introduced into an extruder.

A subject-matter of the invention is also a polydiene/polyamide block thermoplastic elastomer (TPE) copolymer of comb structure comprising units bearing a pendant polyamide along the chain which is bonded to the latter via a group resulting from the reaction, with an epoxide functional group, of an amine or carboxylic acid functional group of the polyamide. Thus, the polydiene/polyamide block TPE consists of a central polydiene block comprising one or more units bearing a polyamide block. The polyamide block is bonded to the unit of the central block via a group resulting from the reaction, with a pendant epoxide functional group borne by the polydiene, of an amine or carboxylic acid functional group of the polyamide.

Another subject-matter of the invention is a rubber composition comprising a TPE according to the invention.

Another subject-matter of the invention is a tread comprising the rubber composition in accordance with the invention.

A further subject-matter of the invention is a tyre comprising the rubber composition in accordance with the invention, in particular in its tread.

### Advantages of the Invention

Advantageously, the process according to the invention makes it possible to obtain TPEs having improved mechanical and hysteresis properties which make it possible to overcome the disadvantages of the known materials and processes.

Ideally, a tread should offer a tyre a very good level of road behaviour on a motor vehicle. This level of road behaviour can be contributed by the use, in the tread, of a rubber composition carefully chosen due to its rather high stiffness in the cured state. In order to increase the stiffness in the cured state of a rubber composition, it is known, for example, to increase the content of filler or to reduce the content of plasticizer in the rubber composition or also to introduce styrene and butadiene block copolymers having a high styrene content into the rubber composition. However, some of these solutions generally have the disadvantage of increasing the hysteresis of the rubber composition.

A high hysteresis implies a high rolling resistance, while a low hysteresis is synonymous with a lower rolling resistance. The hysteresis depends especially on the viscosity and on the elasticity of the materials used in the tyre. The hysteresis and consequently the rolling resistance strongly conditions the fuel consumption.

Conversely, weakly hysteretic compositions generally exhibit a low stiffness in the cured state. It may prove to be necessary to overcome this fall in stiffness in the cured state in order to provide satisfactory road behaviour. Patent Application WO-2011/045131 describes a solution which makes it possible to increase the stiffness in the cured state of a weakly hysteretic rubber composition. This solution consists in introducing glycerol into the rubber composition. The Applicant Companies have also described, in another Patent Application WO-2015/059271, a solution which makes it possible to increase the stiffness in the cured state of a weakly hysteretic rubber composition by introducing a 1,3-dipolar compound into a diene rubber composition reinforced with a filler.

The Applicant Companies, continuing their efforts to obtain a rubber composition which is stiff in the cured state and weakly hysteretic, have discovered that the use of a diene elastomer comprising polyamides along its main chain in a rubber composition makes it possible to achieve this aim.

### Definitions

Any interval of values denoted by the expression “between a and b” represents the range of values extending from more than a to less than b (that is to say, limits a and b excluded), whereas any interval of values denoted by the expression “from a to b” means the range of values extending from a to b (that is to say, including the strict limits a and b).

Furthermore, the term “phr” means, within the meaning of the invention, parts by weight per hundred parts of total elastomer, thus including therein the diene/polyamides thermoplastic elastomer copolymer obtained according to the invention.

In the present description, unless expressly indicated otherwise, all the percentages (%) shown are percentages by weight.

The compounds mentioned in the description and participating in the preparation of rubber compositions or polymers can be of fossil or biobased origin. In the latter case, they may partially or completely result from biomass or be obtained from renewable starting materials resulting from biomass. Polymers, plasticizers, fillers, and the like, are concerned in particular.

### Elastomer

Diene elastomer should be understood, according to the invention, as meaning any polymer resulting, at least in part (i.e., a homopolymer or a copolymer), from diene monomers (monomers bearing two conjugated or non-conjugated carbon-carbon double bonds).

Diene elastomer capable of being used in the invention is understood more particularly to mean a diene elastomer corresponding to one of the following categories:
(a) any homopolymer obtained by polymerization of a conjugated diene monomer having from 4 to 12 carbon atoms;
(b) any copolymer obtained by copolymerization of one or more conjugated dienes having from 4 to 12 carbon atoms with one another or with one or more ethylenically unsaturated monomers;
(c) any homopolymer obtained by polymerization of a non-conjugated diene monomer having from 5 to 12 carbon atoms;
(d) any copolymer obtained by copolymerization of one or more non-conjugated dienes having from 5 to 12 carbon atoms with one another or with one or more ethylenically unsaturated monomers, the copolymer comprising less than 40% by weight, advantageously less than 30% by weight, more advantageously less than 20% by weight, of constitutional units resulting from one or more ethylenically unsaturated monomers;
(e) natural rubber;
(f) a mixture of several of the elastomers defined in (a) to (e) with one another.

In particular, a diene elastomer corresponding to one of the categories (a), (b), (c), (e) and a mixture of several of these elastomers (a), (b), (c), (e) with one another.

Mention may be made, as conjugated diene monomer appropriate for the synthesis of the elastomers, of 1,3-butadiene (hereinafter denoted butadiene), 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

Mention may be made, as non-conjugated diene monomer appropriate for the synthesis of the elastomers, of 1,4-pentadiene, 1,4-hexadiene, ethylidenenorbornene or dicyclopentadiene.

Mention may be made, as ethylenically unsaturated monomers capable of playing a part in the copolymerization with one or more conjugated or non-conjugated diene monomers, in order to synthesize the elastomers, of:
vinylaromatic compounds having from 8 to 20 carbon atoms, such as, for example, styrene, ortho-, meta- or para-methylstyrene, the vinylmesitylene commercial mixture, divinylbenzene or vinylnaphthalene;
(non-aromatic) monoolefins, such as, for example, ethylene and α-olefins, in particular propylene or isobutene;
(meth)acrylonitrile or (meth)acrylic esters.

Among these, the diene polymer or polymers used in the invention are very particularly selected from the group of the diene polymers consisting of polybutadienes (abbreviated to “BRs”), synthetic polyisoprenes (IRs), natural rubber (NR), butadiene copolymers, isoprene copolymers, copolymers of ethylene and of conjugated diene, and the mixtures of these polymers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs), halogenated or non-halogenated butyl rubbers, and copolymers of ethylene and of butadiene (EBRs). The elastomers can have any microstructure, which depends on the polymerization conditions used, in particular on the presence or absence of a modifying and/or randomizing agent and on the amounts of modifying and/or randomizng agent employed.

The elastomers can, for example, be block, random, sequential or microsequential elastomers and can be prepared in dispersion or in solution; they can be coupled and/or star-branched or else functionalized by a coupling and/or star-branching or functionalization agent.

### Polymer of Comb Structure

The expression “polymer of comb structure” should be understood as meaning, within the meaning of the invention, a polymer comprising a main chain to which side groups (grafts) are attached. Preferably, the polymers of comb structure comprise polyamide side groups.

In the present description, the expression “graft” should be understood as meaning the side group, especially polyamide side group, fixed to the main chain of the diene elastomer by grafting.

### Diene Elastomer Functionalized by at Least One Epoxide Functional Group

The expression “diene elastomer functionalized by at least one epoxide functional group” should be understood as meaning, within the meaning of the invention, an elastomer exhibiting at least one epoxide functional group which is reactive with regard to an amine or carboxylic acid group borne by the polyamide. This epoxide functional group is capable of reacting with the end amine or carboxylic acid group of the polyamide in order to obtain the grafting of the side groups. The epoxide functional group is located along the main chain of the polymer, preferably via a spacer group. The epoxide functional group is advantageously monosubstituted, that is to say substituted solely by the spacer group or by its bond to the main chain of the diene elastomer. Thus, the carbon atom of the epoxide functional group connected, advantageously via a spacer, to the main chain of the diene elastomer also bears a hydrogen atom, as emerges in the formula (I) below:

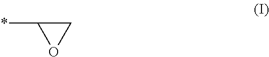 [SMILES: *C1CO1]

where * represents the point of connection with a spacer group or with the main chain of the diene elastomer.

### Along the Main Chain

The expression “along the main chain” should be understood as meaning, within the meaning of the invention, a random distribution along the main chain. This expression refers to a pendant group of the polymer, at several places on the chain. This includes the end or ends of the chain but is not limited to these locations. When a group is present at at least one chain end, the polymer also comprises at least one other pendent group of this type at another position in the chain.

### Spacer

The expression “spacer group” should be understood as meaning, within the meaning of the invention, a divalent hydrocarbon chain which can contain one or more aromatic radicals and/or one or more heteroatoms, such as silicon. The hydrocarbon chain can optionally be substituted.

The expression “(C₁-Cₘ)alkyl” or the expression “C₁-Cₘ alkyl group” should be understood as meaning, within the meaning of the invention, a saturated, linear or branched, monovalent hydrocarbon chain comprising from 1 to m carbon atoms, with m being an integer from 2 to 18. For example, the expression (C₁-C₁₀)alkyl is a hydrocarbon chain comprising from 1 to 10 carbon atoms, that is to say m=10. Mention may be made, by way of example, of the methyl, ethyl, propyl, isopropyl, butyl, isobutyl, sec-butyl, tert-butyl, pentyl or hexyl groups.

The term “C₆-C₁₄ aryl” should be understood as meaning, within the meaning of the invention, an aromatic hydrocarbon group preferably comprising from 6 to 14 carbon atoms and comprising one or more fused rings, such as, for example, a phenyl, naphthyl or anthracenyl group. Advantageously, it is the phenyl.

The expression “C₇-C₁₁ alkylaromatic” should be understood as meaning, within the meaning of the invention, an “aryl(C₁-C₁₀)alkyl”, “aralkyl” or “(C₁-C₁₀)alkylaryl” group defined below. Mention may be made, by way of example, of the benzyl, tolyl and xylyl radicals.

The expression “(C₂-C₂₀)alkenyl” group is understood to mean, within the meaning of the present invention, a linear or branched monovalent hydrocarbon chain comprising at least one double bond and comprising from 2 to 20 carbon atoms. Mention may be made, by way of example, of the ethenyl or allyl groups.

The expression “aryl(C₁-C₁₀)alkyl” or “aralkyl” should be understood as meaning, within the meaning of the invention, an aryl group as defined above bonded to the remainder of the molecule via a (C₁-C₁₀)alkyl chain as defined above. Mention may be made, by way of example, of the benzyl group.

The expression “(C₁-C₁₀)alkylaryl” should be understood as meaning, within the meaning of the invention, a (C₁-C₆)alkyl group as defined above bonded to the remainder of the molecule via an aryl group as defined above. Mention may be made, by way of example, of the tolyl (CH₃Ph) group or the xylyl ((CH₃)₂Ph) group.

### DETAILED DESCRIPTION OF EXAMPLE EMBODIMENTS

A subject-matter of the present invention is a process for the preparation of a polydiene/polyamide block thermoplastic elastomer (TPE) copolymer of comb structure, the percentage by weight of polyamide of which is between 10% and 35% by weight, with respect to the weight of the copolymer, characterized in that polyamide and a diene elastomer functionalized by at least one pendant epoxide functional group along the main chain are introduced into an extruder, the said diene elastomer corresponding to one of the following categories:
(a) any homopolymer obtained by polymerization of a conjugated diene monomer having from 4 to 12 carbon atoms;
(b) any copolymer obtained by copolymerization of one or more conjugated dienes having from 4 to 12 carbon atoms with one another or with one or more ethylenically unsaturated monomers;
(c) any homopolymer obtained by polymerization of a non-conjugated diene monomer having from 5 to 12 carbon atoms;
(d) any copolymer obtained by copolymerization of one or more non-conjugated dienes having from 5 to 12 carbon atoms with one another or with one or more ethylenically unsaturated monomers, the copolymer comprising less than 40% by weight, advantageously less than 30% by weight, more advantageously less than 20% by weight, of constitutional units resulting from one or more ethylenically unsaturated monomers;
(e) natural rubber;
(f) a mixture of several of the elastomers defined in (a) to (e) with one another.

In particular, a diene elastomer corresponding to one of the categories (a), (b), (c), (e) and a mixture of several of these elastomers (a), (b), (c), (e) with one another.

The reaction of a diene elastomer functionalized by at least one pendant epoxide functional group along the main chain with a polyamide is a grafting stage. It is a matter of grafting polyamide grafts to the main chain, via the epoxide functional group present along the chain. In order to make this grafting possible, the diene elastomer chain comprises units functionalized by pendant epoxide functional groups. The grafting of the side polyamides to the main polymeric chain (backbone) can be carried out according to different techniques and by any suitable process.

The functionalized diene elastomer of use for the requirements of the invention thus bears pendant epoxide functional groups. In these pendant groups, the epoxide functional group is advantageously monosubstituted.

The epoxide functional group can, on the one hand, either already be present in a monomer involved in the copolymerization with the other constituent monomer(s) of the polymer (this monomer can, for example, be glycidyl methacrylate, allyl glycidyl ether or vinyl glycidyl ether) or, on the other hand, be obtained by the post-polymerization modification of the carbon-based backbone of the elastomer or of a pendant functional group of the diene elastomer, or be obtained by functionalization of the living elastomer resulting from the anionic polymerization with a functionalization agent bearing an epoxide functional group.

According to an alternative form of the invention, the diene elastomer is modified post-polymerization in order to introduce pendant epoxide functional groups along the chain and more particularly by post-polymerization modification of the carbon-based backbone of the elastomer. Thus, according to this specific alternative form, the process according to the invention can comprise an additional stage of functionalization in particular by a hydrosilylation reaction of a diene elastomer, in order to obtain a diene elastomer functionalized by pendant epoxide functional groups along the main chain. Such epoxidized diene elastomers and the process by which they are obtained are described in particular in WO-2015/091020 A1.

The diene elastomer to be functionalized by pendant epoxide functional groups along the main chain preferably exhibits a degree of crystallinity within a range extending from 0% to 10%. Advantageously, the elastomer is amorphous.

The diene elastomer to be functionalized by pendant epoxide functional groups along the main chain preferably exhibits a number-average molar mass, Mn, ranging from 50 000 g/mol to 500 000 g/mol, so as to confer, on the TPE, good elastomeric properties and a mechanical strength which is sufficient and compatible with the use, in particular as tyre tread. The molar mass is determined by the method described in the appendix, according to the polystyrene equivalent size exclusion chromatography (SEC) method. The diene elastomer advantageously exhibits a number-average molar mass ranging from 100 000 g/mol to 500 000 g/mol.

Advantageously, the number-average molar mass, Mn, of the functionalized diene elastomer varies from 50 000 g/mol to 500 000 g/mol, determined according to the polystyrene equivalent size exclusion chromatography (SEC) method described in the appendix. The functionalized diene elastomer advantageously exhibits a number-average molar mass ranging from 100 000 g/mol to 500 000 g/mol.

Preferably, the diene elastomer to be functionalized by pendant epoxide functional groups along the main chain and employed according to the process of the invention is as defined below. Preferably, the diene elastomer comprises 1,3-diene units; more preferably, it is 1,3-butadiene or 2-methyl-1,3-butadiene. Preferably, the diene elastomer is chosen from polybutadienes (BRs), synthetic polyisoprenes (IRs), natural rubber (NR), butadiene copolymers, isoprene copolymers, ethylene/diene copolymers and the mixtures of these polymers.

### Functionalization by Hydrosilylation

According to a specific alternative form of the invention, the diene elastomer is functionalized by hydrosilylation. It concerns a modification of the polymer comprising unsaturations along the chain by hydrosilylation, the unsaturations of the polymer being reacted with an epoxidized hydrosilane of formula (II) below in the presence of a catalyst, according to the process described in Patent Application WO-2015/091020:

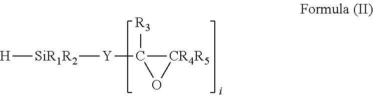

with
:R₁ and R₂, which are identical or different, each being a C₁-C₅ alkyl or C₆-C₁₄ aryl or C₇-C₁₁ alkylaromatic group;
R₃, R₄ and R₅, which are identical or different, each being a hydrogen atom or a C₁-C₅ alkyl or C₆-C₁₄ aryl or C₇-C₁₁ alkylaromatic group;
Y being a bridging group with a valency equal to i+1; and
i being an integer with a value ranging from 1 to 3.

Advantageously, R₃ represents a hydrogen atom.

Advantageously, R₄ and R₅, which are identical or different, are each a hydrogen atom or a C₁-C₂ alkyl group. More advantageously, R₄ and R₅ are each a hydrogen atom.

According to alternative forms, in the formula (II), R₃, R₄ and R₅ are preferably identical and represent a hydrogen atom.

According to alternative forms, in the formula (II), R₁ and R₂, which are identical or different, preferably denote a C₁-C₅ alkyl group.

According to yet other alternative forms, in the formula (II), Y preferably represents a linear, branched or cyclic hydrocarbon chain which can contain one or more aromatic radicals and/or one or more heteroatoms, such as, for example, N, O or Si.

According to a preferred embodiment, the bridging group Y is a linear or branched C₁-C₂₄, preferably C₁-C₁₀, alkyl chain, optionally interrupted by one or more silicon and/or oxygen atoms. More preferably, Y is a linear C₁-C₆ alkyl chain interrupted by one or more silicon and/or oxygen atoms. When the hydrocarbon chain Y comprises at least one silicon atom, the latter can preferentially be substituted by at least one C₁-C₄ alkyl radical, preferably methyl or ethyl. When the hydrocarbon chain Y comprises at least one oxygen atom, the latter is preferably separated from the epoxy group by a methylene group.

After functionalization, a diene elastomer functionalized by at least one pendant epoxide functional group along the main chain is obtained.

Advantageously, the pendant epoxide functional group along the chain of the copolymer according to the invention corresponds to the formula (III):

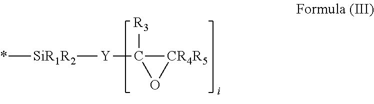

with:
R₁ and R₂, which are identical or different, each being a C₁-C₅ alkyl or C₆-C₁₄ aryl or C₇-C₁₁ alkylaromatic group;
R₃, R₄ and R₅, which are identical or different, each being a hydrogen atom or a C₁-C₅ alkyl or C₆-C₁₄ aryl or C₇-C₁₁ alkylaromatic group, and preferably a hydrogen atom;
Y being a bridging group with a valency equal to i+1; and
i being an integer with a value ranging from 1 to 3, and preferably 1;
* denoting a point of connection with the polymer chain.

Advantageously, R₃ represents a hydrogen atom.

Advantageously, R₄ and R₅, which are identical or different, are each a hydrogen atom or a C₁-C₂ alkyl group. More advantageously, R₄ and R₅, which are identical, are each a hydrogen atom.

According to alternative forms, in the formula (III), R₃, R₄ and R₅ are preferably identical and represent a hydrogen atom.

Advantageously, the functionalized diene elastomer comprises units bearing a pendant epoxide functional group along the chain which is connected to the latter via a silicon atom, according to a molar content of at least 0.1% and of at most 20%, and non-epoxidized units (not bearing an epoxide functional group) according to a molar content of at most 99.9% and of at least 80%, the molar contents being defined with respect to the polymer.

Functionalization with a Modifying Agent Comprising at Least One Nitrogenous Dipole, Such as, for Example, Nitrile Oxides, Nitrones or Nitrilimines.

According to a specific alternative form of the invention, the diene elastomer is functionalized by cycloaddition of a nitrogenous dipole, such as, for example, nitrile oxides, nitrones or nitrilimines, bearing the epoxide functional group of interest. It concerns the grafting of a modifying agent of formula (IV) by [3+2]-cycloaddition of the reactive group(s) of the modifying agent and one or more double bonds of the chain of the elastomer, according to the process described in Patent Applications WO-2012/007442 (especially pages 19 and 20) and US20120464178:

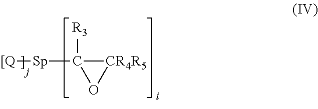

with:
Q being a group comprising a dipole containing at least and preferably one nitrogen atom;
Sp being an atom or a group of atoms forming a bond between Q and the epoxide;
R₃, R₄ and R₅, which are identical or different, each being a hydrogen atom or a C₁-C₅ alkyl or C₆-C₁₄ aryl or C₇-C₁₁ alkylaromatic group, and preferably a hydrogen atom;
i and j, which are identical or different, being an integer with a value ranging from 1 to 2, and preferably equal to 1.

Advantageously, R₃ represents a hydrogen atom.

Advantageously, R₄ and R₅, which are identical or different, are each a hydrogen atom or a C₁-C₂ alkyl group. More advantageously, R₄ and R₅, which are identical, are each a hydrogen atom.

According to alternative forms, in the formula (IV), R₃, R₄ and R₅ are preferably identical and represent a hydrogen atom.

Dipole is understood to mean a functional group capable of forming a [1,3]-dipolar addition on an unsaturated carbon-carbon bond.

The group Q is capable of being bonded to the diene elastomer chain by a covalent bond (grafting). Preferably, the group Q comprises a nitrile oxide, nitrone or nitrilimine functional group which can be bonded to a polymer bearing at least one unsaturation by a cycloaddition of [3+2] type.

Preferably, the group Q is a group of following formula (V), (VI) or (VII):

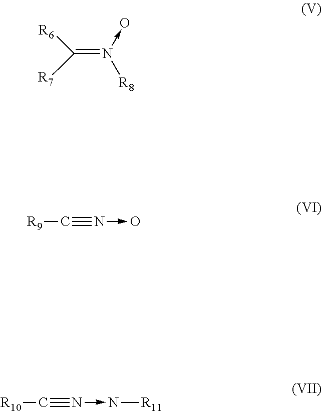

in which R₆ to R₁₁ are independently chosen from a spacer group Sp, a hydrogen atom, a linear or branched C₁-C₂₀ alkyl group, a linear or branched C₃-C₂₀ cycloalkyl group, a linear or branched C₆-C₂₀ aryl group and a group of formula (VIII):

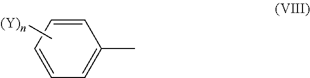

in which n represents 1, 2, 3, 4 or 5 and each Y independently represents a spacer group Sp, an alkyl group or a halide.

The “spacer” group Sp makes it possible to connect at least one group Q and/or at least one epoxide and thus can be of any type known per se. However, the “spacer” group must not, or only slightly, interfere with the Q and epoxide groups.

The said “spacer” group is thus regarded as a group which is inert with regard to the group Q. The “spacer” group is preferably a linear, branched or cyclic hydrocarbon chain which can contain one or more aromatic radicals and/or one or more heteroatoms. The said chain can optionally be substituted, provided that the substituents are inert with regard to the Q groups.

According to a preferred embodiment, the “spacer” group is a linear or branched C₁-C₂₄, preferably C₁-C₁₀, alkyl chain and more preferably a linear C₁-C₆ alkyl chain, optionally comprising one or more heteroatoms chosen from nitrogen, sulfur, silicon or oxygen atoms.

### Extrusion

During the reactive extrusion, the polyamide reacts with the epoxide functional group borne by the group of the functionalized elastomer by opening of the said epoxide ring.

Advantageously, during the reactive extrusion, it is possible, in a first step, to functionalize the elastomer with pendant epoxide functional groups via a modifying agent comprising at least one nitrogenous dipole and one epoxide functional group in an upstream zone of the extrusion screw and then to graft polyamide to these pendant epoxide functional groups in another downstream zone of the extrusion screw.

The term “upstream zone” refers to the zone closer to the feed hopper of the extruder screw and the term “downstream zone” refers to the zone closer to the outlet of the extruder screw.

### Polyamide

The term “polyamide” should be understood as meaning, within the meaning of the invention, a polyamide, an oligoamide, a homopolyamide or a copolyamide terminated by a primary amine functional group or a carboxylic acid functional group. Preferably, it is a primary amine functional group, which exhibits a good reactivity with regard to acid, acid salt, anhydride or epoxide, preferably epoxide, functional groups.

Advantageously, the polyamide has a melting point of between 100 and 300° C., preferably between 140 and 250° C.

The term “homopolyamide” should be understood as meaning, within the meaning of the invention, the condensation products of a lactam (or of the corresponding amino acid) or of a diacid with a diamine (or their salts). The chain limiter, which can be a diacid, a monoacid, a diamine or a monoamine, in the case of the lactams, and another diacid or another diamine, in the case of the polyamides resulting from the condensation of a diamine with a diacid, is not take into account.

The term “copolyamide” should be understood as meaning, within the meaning of the invention, homopolyamides in which there is at least one monomer more than necessary, for example two lactams or one diamine and two acids or also one diamine, one diacid and one lactam.

Preferably, the polyamide is chosen from PA 6, PA 6-6, PA 11, PA 12 and their copolymers. Preferably, it is PA11 and PA12.

According to a first type, the copolyamide results from the condensation of at least two α,ω-aminocarboxylic acids or of at least two lactams having from 6 to 12 carbon atoms or of a lactam and of an aminocarboxylic acid not having the same number of carbon atoms. The copolyamide of this first type can also comprise units which are residues of diamines and of dicarboxylic acids.

Mention may be made, as example of dicarboxylic acid, of diacids such as isophthalic, terephthalic, adipic, azelaic, suberic, sebacic, nonanedioic and dodecanedioic acid.

Mention may be made, as example of diamine, of hexamethylenediamine, dodecamethylenediamine, meta-xylylenediamine, bis(p-aminocyclohexyl)methane and trimethylhexamethylenediamine.

Mention may be made, as example of α,ω-aminocarboxylic acid, of aminocaproic acid, aminoundecanoic acid and aminododecanoic acid.

Mention may be made, as example of lactam, of caprolactam, oenantholactam and laurolactam.

According to a second type, the copolyamide results from the condensation of at least one α,ω-aminocarboxylic acid (or one lactam), at least one diamine and at least one dicarboxylic acid. The α,ω-aminocarboxylic acid, the lactam and the dicarboxylic acid can be chosen from those mentioned above. The diamine can be a linear, branched or cyclic aliphatic diamine or also an arylic diamine. Mention may be made, as examples, of hexamethylenediamine, piperazine, isophoronediamine (IPD), methylpentamethylenediamine (MPDM), bis(aminocyclohexyl)methane (BACM) or bis(3-methyl-4-aminocyclohexyl)methane (BMACM).

In order for the polyamide to be terminated by a primary amine functional group, use may be made of a chain limiter of formula:

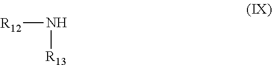

in which R₁₂ is a hydrogen atom or a (C₁-C₂₀)alkyl group and R₁₃ is a (C₁-C₂₀)alkyl or (C₂-C₂₀)alkenyl group; a limiting cycloaliphatic radical can, for example, be laurylamine or oleylamine.

The polyamide terminated by a primary amine or acid functional group has a number-average molecular weight (Mn) of between 1000 and 50 000 g/mol, rather of between 100 and 30 000 g/mol, advantageously of between 1500 and 20 000 g/mol. This average molecular weight is determined by NMR according to the protocol described in the introduction to the examples.

The polyamides can be manufactured according to processes known to a person skilled in the art, for example by polycondensation in an autoclave. The polycondensation is carried out at a temperature of generally between 200 and 300° C., under vacuum or under an inert atmosphere, with stirring of the reaction mixture.

Advantageously, the process according to the invention comprises the following stages:
a) introduction, into an extruder, of the polyamide and of the said functionalized elastomer;
b) mixing of the components introduced in stage a) and heat treatment at a temperature greater than the melting point of the polyamide; then
c) recovery of the polydiene/polyamide block thermoplastic elastomer copolymer of comb structure at the outlet of the extruder.

The functionalized elastomer and the polyamide are as described above.

Advantageously, during the stage a), it is possible, in a first step, to functionalize the elastomer with pendant epoxide functional groups via a modifying agent comprising at least one nitrogenous dipole and one epoxide functional group in an upstream zone of the extrusion screw and then to graft polyamide to these pendant epoxide functional groups in another downstream zone of the extrusion screw.

Stages a) and b) make it possible to homogenize the mixture and to provide for the subsequent grafting reaction to take place in an optimal manner.

During stage a), the polyamide and the functionalized diene elastomer are introduced in controlled amounts. Advantageously, the percentage by weight of polyamide introduced, with respect to the total weight of functionalized diene elastomer introduced and of polyamide introduced, varies from 10% to 35% by weight, preferably from 15% to 35%. Advantageously, during stage a), all of the functionalized elastomer is introduced. Advantageously, during stage a), all of the polyamide is introduced.

Stages a) and b) are advantageously carried out under inert conditions, for example while flushing with an inert gas, such as nitrogen, in order to prevent any decomposition of the elastomer and of the polyamide.

Any type of extruder which makes possible the mixing of components can be used: single-screw extruder, two-stage extruder or co-kneader, twin-screw extruder, planetary gear extruder or ring extruder. Twin-screw extruders are particularly suitable. The extruder can make possible a continuous or batchwise process.

The L/D (length/diameter) ratio of the extruder is adapted according to the reaction time, which is dependent on the flow rate and on the residence time. The L/D ratio can, for example, be greater than 20, more advantageously greater than 40. It can, for example, be 56 for a continuous twin-screw extruder and a residence time of less than 30 minutes. It can, for example, be 5 or 6 for a microextruder (batchwise process) and a reaction time of less than 30 minutes.

Advantageously, the heat treatment stage b) of the process according to the invention is carried out at a temperature ranging from 170° C. to 230° C., preferably from 175° C. to 220° C.

Advantageously, the duration of stage b) of the process according to the invention is less than 30 minutes, preferably less than 25 minutes, more preferably less than 20 minutes, more preferably still equal to 20 minutes.

Advantageously, the process according to the invention is carried out in bulk. Thus, the polyamide and the functionalized diene elastomer are introduced without solvent. In particular, no solvent is added during the implementation of the process according to the invention.

The process according to the invention makes it possible to obtain grafting of the polyamide with time periods compatible with an industrial use.

In a first embodiment, the process is a continuous or semi-continuous process. Stages a) to c) will thus be simultaneous and will take place in different zones of the extruder. For example, stage a) will be carried out in a feed zone (located upstream in the extruder) and then stage b) will be carried out in a mixing zone.

It is understood that the upstream lies in the extruder head (feed zone). With respect to a reference point, a downstream zone is a zone closer to the outlet of the extruder.

On conclusion of the process according to the invention or on conclusion of stage c), a polydiene/polyamide block thermoplastic elastomer (TPE) copolymer of comb structure is obtained.

The TPE obtained can additionally comprise units bearing a pendant epoxide functional group along the residual chain which has not reacted with a polyamide.

Advantageously, the percentage by weight of polyamide in the polydiene/polyamide block TPE of comb structure obtained according to the invention is between 10% and 35% by weight, with respect to the weight of the TPE.

Advantageously, the percentage by weight of polyamide in the polydiene/polyamide block TPE of comb structure obtained according to the invention varies from 15% to 35% by weight, with respect to the weight of the TPE.

The TPE obtained according to the invention withstands very large strains before breaking, but may flow at a temperature greater than the melting point of the polyamide, that is to say greater than 150° C., indeed even greater than 170° C.

In particular, the TPE according to the invention exhibits an elongation at break of at least 50%, as measured by the method described before the examples, “Mechanical tests” section, preferably 100%.

When the TPEs obtained by the process according to the invention are studied by dynamic mechanical analysis, the presence of a rubbery plateau over a broad temperature range, ranging from the glass transition temperature of the elastomer block to the melting point of the polyamide block, for example ranging from −20° C. to 90° C. for the TPEs exemplified, is observed. When the TPEs obtained by the process according to the invention are studied by dynamic mechanical analysis, the presence of a rubbery plateau without fall in modulus is observed.

Another subject-matter of the invention is the TPE obtained by the process according to the invention, described above.

Another subject-matter of the invention is the mixture obtained by the process according to the invention. This mixture comprises TPE and can additionally comprise unreacted elastomer and polyamide, or other starting material(s) used for the grafting reaction.

### Thermoplastic Elastomer (TPE) Copolymer

Another subject-matter of the invention is a polydiene/polyamide block thermoplastic elastomer (TPE) copolymer of comb structure comprising units bearing a pendant polyamide along the chain which is bonded to the latter via a group resulting from the reaction, with a pendant epoxide functional group of the polydiene, of an amine or carboxylic acid functional group of the polyamide.

Thus, another subject-matter of the invention is a polydiene/polyamide block (TPE) thermoplastic elastomer copolymer of comb structure. This TPE consists of a polydiene main chain comprising one or more units bearing a polyamide. The polyamide block is bonded to a unit of the central block via a group resulting from the reaction, with a pendant epoxide functional group of the polydiene, of an amine or carboxylic acid functional group of the polyamide.

In an alternative form of the invention, these epoxide functional groups are bonded to the chain via at least one silicon atom.

The TPE according to the invention is of formula (X) below:

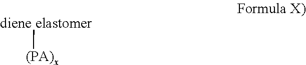

with x being the number of grafts and PA the polyamide.

The TPE according to the invention can additionally comprise units bearing a pendant epoxide functional group along the residual chain which has not reacted with a polyamide.

Advantageously, the percentage by weight of polyamide of the TPE according to the invention is between 10% and 35% by weight, with respect to the weight of the TPE.

Advantageously, the percentage by weight of polyamide of the TPE according to the invention varies from 15% to 35% by weight, with respect to the weight of the TPE.

The TPE according to the invention withstands very large strains before breaking, but may flow at a temperature greater than the melting point of the polyamide, that is to say greater than 150° C., indeed even greater than 170° C.

In particular, the TPE according to the invention exhibits an elongation at break of at least 50%, as measured by the method described before the examples, “Mechanical tests” section, preferably 100%.

When the TPEs according to the invention are studied by dynamic mechanical analysis, the presence of a rubbery plateau over a broad temperature range, ranging from the glass transition temperature of the elastomer block to the melting point of the polyamide block, for example ranging from −20° C. to 90° C. for the TPEs exemplified, is observed. When the TPEs according to the invention are studied by dynamic mechanical analysis, the presence of a rubbery plateau without fall in modulus is observed.

### Compositions

Another subject-matter of the invention is a rubber composition comprising at least one polydiene/polyamide block thermoplastic elastomer (TPE) copolymer of comb structure according to the invention or obtained by the process according to the invention.

Another subject-matter of the invention is a composition comprising at least 50% by weight of a TPE according to the invention. Another subject-matter of the invention is a composition comprising the mixture obtained by the process according to the invention, advantageously in an amount of at least 50% by weight. In particular, the TPE or the mixture obtained according to the invention can be the predominant polymer by weight of the composition, indeed even the only polymer of the composition. The mixture obtained according to the invention can comprise, besides the TPE according to the invention, the functionalized elastomer and the polyamide, if appropriate the elastomer to be functionalized and the modifying agent comprising at least one nitrogenous dipole and one epoxide functional group, which were introduced during stage a), which have not reacted.

The composition is advantageously a rubber composition, especially a composition which can be used in the manufacture of a tyre. The TPE or the mixture obtained according to the invention is of particular use in the preparation of tread compositions. The TPE or the mixture obtained according to the invention makes it possible to manufacture a tread which makes it possible to obtain a very good compromise in the stiffness and rolling resistance performance qualities.

If optional other elastomers are used in the rubber composition according to the invention, the TPE(s) obtained in accordance with the invention or the elastomers of the mixture obtained according to the invention constitute the predominant fraction by weight; they then represent at least 50% by weight, preferably at least 65% by weight and more preferably at least 75% by weight of the combined elastomers present in the composition. Also preferably, the TPE(s) obtained according to the invention or the elastomers of the mixture obtained according to the invention (TPE+unreacted elastomer) represent at least 95% (especially 100%) by weight of the combined elastomers present in the composition.

Thus, the amount of TPE obtained in accordance with the invention or of elastomers of the mixture obtained according to the invention is within a range which varies from 50 to 100 phr, preferably from 65 to 100 phr and in particular from 75 to 100 phr. Also preferably, the rubber composition according to the invention comprises from 95 to 100 phr of TPE obtained according to the invention or of elastomers of the mixture obtained according to the invention. The TPE(s) obtained according to the invention or the elastomers of the mixture obtained according to the invention are preferably the only elastomer(s) of the rubber composition, especially of the tread.

The rubber composition according to the invention can additionally comprise at least one (that is to say, one or more) other second diene rubber as non-thermoplastic elastomer.

The total content of this other optional additional diene rubber is within a range varying from 0 to 50 phr, preferably from 0 to 35 phr, more preferably from 0 to 25 phr and more preferably still from 0 to 5 phr. Also very preferably, the rubber composition according to the invention does not contain another additional diene rubber.

Second “diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

Second diene elastomer should be understood, according to the invention, as meaning any synthetic elastomer resulting, at least in part, from diene monomers. More particularly, second diene elastomer is understood as meaning any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter contain from 20% to 99% by weight of diene units and from 1% to 80% by weight of vinylaromatic units. The following are suitable in particular as conjugated dienes which can be used in the process in accordance with the invention: 1,3-butadiene, 2-methyl-1,3-butadiene, 2,3-di(C₁ to C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene, 2,4-hexadiene, and the like.

The second diene elastomer of the composition in accordance with the invention is preferably selected from the group of diene elastomers consisting of polybutadienes, synthetic polyisoprenes, natural rubber, butadiene copolymers, isoprene copolymers and the mixtures of these elastomers. Such copolymers are more preferably selected from the group consisting of styrene copolymers (SBRs, SIRs and SBIRs), polybutadienes (BRs) and natural rubber (NR).

### Nanometric or Reinforcing Filler

The TPE(s) or the mixture obtained according to the invention are sufficient in themselves alone for the composition according to the invention to be able to be used, especially the tread.

When a reinforcing filler is used, use may be made of any type of filler commonly used for the manufacture of tyres, for example an organic filler, such as carbon black, an inorganic filler, such as silica, or else a blend of these two types of filler, in particular a blend of carbon black and silica.

In order to couple the reinforcing inorganic filler to the elastomer, it is possible, for example, to use an at least bifunctional coupling agent (or bonding agent) intended to provide a satisfactory connection, of chemical and/or physical nature, between the inorganic filler (surface of its particles) and the elastomer according to the invention, especially bifunctional organosilanes or polyorganosiloxanes.

### Plasticizers

According to one embodiment, the composition can, in addition, also comprise a plasticizing agent, such as an oil (or plasticizing oil or extending oil) or a plasticizing resin, the role of which is to facilitate the processing of the tread, in particular its incorporation in the tyre, by a lowering of the modulus and an increase in the tackifying power.

### Various Additives

The rubber composition of the invention can, in addition, furthermore comprise the various additives normally present in compositions for tyres, in particular treads, known to a person skilled in the art. The choice will be made, for example, of one or more additives chosen from protective agents, such as antioxidants or antiozonants, UV stabilizers, various processing aids or other stabilizers, or else promoters capable of promoting the adhesion to the remainder of the structure of the tyre. Preferably, the composition according to the invention does not contain all these additives at the same time and more preferably still the composition does not contain any of these agents.

In an advantageous alternative form of the invention, mention will very particularly be made of antioxidants, nucleating agents, for example U.S. Pat. No. 3,080,345 describes, as nucleating agent, sodium phenylphosphinate, sodium isobutylphosphinate, magnesium oxide, mercuric bromide, mercuric chloride, cadmium acetate, lead acetate or phenolphthalein. U.S. Pat. Nos. 3,585,264 and 4,866,115 also describe nucleating agents for improving the kinetics of crystallization of polyamides. Highly dispersible silica can be used as nucleating agent. A polyamide-6,6 powder can be used as polyamide nucleating agent with a lower melting point. Other nucleating agents are described in the article by Jansen, J., Nucleating agents for partly crystalline polymers, in Gachter, R. and Muller, H., Plastics Additives Handbook, Hanser Publishers, 1985, Munich, 674-683.

Equally and optionally, the rubber composition according to the invention can contain a crosslinking system known to a person skilled in the art. Preferably, the composition does not contain a crosslinking system. In the same way, the composition can contain one or more inert micrometric fillers, such as lamellar fillers, known to a person skilled in the art. Preferably, the composition does not contain a micrometric filler.

The rubber composition according to the invention can subsequently be calendered, for example in the form of a sheet or of a plaque, in particular for a laboratory characterization, or else extruded, in order to form, for example, a rubber profiled element used as rubber component in the preparation of a tyre.

Another subject-matter of the invention is a tyre comprising the TPE or the mixture which are obtained by the process according to the invention, described above.

Another subject-matter of the invention is a tyre, one of its constituent elements of which comprises a rubber composition according to the invention. This constituent element is advantageously the tread.

This tread can be fitted to a tyre in a conventional way, the said tyre comprising, in addition to the tread according to the invention, a crown, two sidewalls and two beads, a carcass reinforcement anchored to the two beads, and a crown reinforcement. Optionally, the tyre according to the invention can additionally comprise an underlayer or an adhesion layer between the patterned portion of the tread and the crown reinforcement.

A subject-matter of the invention is especially a tyre comprising a tread, a crown with a crown reinforcement, two sidewalls, two beads, a carcass reinforcement anchored to the two beads and extending from one sidewall to the other, in which the tread comprises at least one thermoplastic elastomer, the said thermoplastic elastomer being a copolymer according to the invention, and the total content of thermoplastic elastomer being within a range varying from 50 to 100 phr (parts by weight per hundred parts of elastomer).

### Preparation

The TPE or the mixture which are obtained according to the invention can be processed in a way conventional for TPEs, by extrusion or moulding, for example using a starting material available in the form of beads or granules.

Thus, according to a specific embodiment of the invention, the TPEs, the mixture or the rubber composition in accordance with the invention, which can either be in the raw state (before crosslinking or vulcanization) or in the cured state (after crosslinking or vulcanization).

The tread for the tyre according to the invention can be prepared by incorporation of the various components in a mixer, then use of a die which makes it possible to prepare the profiled element. The tread is subsequently patterned in the mould for curing the tyre. The various components can, for example, be the TPE or the mixture which are obtained according to the invention, which are described above, if appropriate one or more of the other additives described above. The various components can also be the TPE according to the invention or a mixture according to the invention, a second diene rubber as are described above and, if appropriate, one or more of the other additives described above.

### EXAMPLES

### 1. Abbreviations

The following abbreviations are used:
SBR styrene/butadiene elastomer (styrene/butadiene rubber)
EBR ethylene/butadiene elastomer (ethylene/butadiene rubber)
PA polyamide
1,2-PB 1,2-butadiene (vinyl) units
1,4-PB 1,4-butadiene units
PS styrene units
Mol molar
Wt by weight
DSC differential scanning calorimetry
SEC size exclusion chromatography

### 2. Determination of the Molar Masses

a) Molar Mass of the Functionalized or Non-Functionalized Diene Elastomer

It is determined by polystyrene equivalent size exclusion chromatography (SEC).

i) Principle of the measurement:

SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polymolecularity or polydispersity index (PI=Mw/Mn) can be calculated via a “Moore” calibration.

ii) Preparation of the polymer:

There is no specific treatment of the polymer sample before analysis. The latter is simply dissolved in chloroform at a concentration of approximately 2 g/l. The solution is then filtered through a filter with a porosity of 0.45 μm before injection.

iii) SEC analysis:

The apparatus used is an “Agilent 1200” chromatograph. The elution solvent is chloroform. The flow rate is 0.7 ml/min, the temperature of the system is 35° C. and the analytical time is 90 min. A set of four Waters columns in series, with commercial names Styragel HMW7, Styragel HMW6E and two Styragel HT6E, is used. The volume of the solution of the polymer sample injected is 100 μl. The detector is a Waters 2010 differential refractometer and the software for making use of the chromatographic data is the “Waters Empower” system. The calculated average molar masses are relative to a calibration curve prepared from “PSS Ready Cal-Kit” commercial polystyrene standards.
b) Molar Mass of the Polyamide

The ¹H NMR analyses are carried out with the aim of quantifying the carboxylic acid and amine chain ends of the polyamide and of estimating the mean chain lengths.

The samples (approximately 20 mg) are dissolved in 1 ml of hexafluoroisopropanol (HFIP) and introduced into a 5 mm NMR tube. The spectra are recorded on an Avance III HD 500 MHz Bruker spectrometer equipped with a BBFO 1H-X 5 mm Z_GRD probe. The spectra are calibrated with regard to the ¹H signal of the HFIP at 4.50 ppm.

The quantitative ¹H NMR experiment used is a simple pulse sequence with a tip angle at 30° and a repetition time of 5 seconds between each acquisition. 64 accumulations are recorded at ambient temperature.

The assignments of the ends of chains and middle of chain units are given below:
CH₂-acid end of chain unit at δ ¹H=2.47 ppm
CH₂-amine end of chain unit at δ ¹H=3.22 ppm
CH₂—CO amide middle of chain unit at δ ¹H=2.36 ppm
CH₂—N amide middle of chain unit at δ ¹H=3.36 ppm

The number-average molar masses, Mn, are calculated from the preceding integrations.

### 3. Analysis by NMR of the Content of Pendant Epoxide Functional Groups Borne by the Elastomer

### ¹H NMR

The amount of the epoxide functional groups borne by the elastomer is determined by ¹H NMR in solution in deuterated chloroform.

The samples (approximately 20 mg of elastomer) are dissolved in 1 ml of CDCl₃ and introduced into a 5 mm NMR tube. The spectra are recorded using an Avance III HD 500 MHz Bruker spectrometer equipped with a BBFO 1H-X 5 mm Z_GRD probe. The ¹H NMR experiment used for the identification of the entities is a simple pulse sequence with a tip angle at 30° and a repetition time of 5 seconds between each acquisition. 64 accumulations are recorded at ambient temperature. The spectra are calibrated with regard to the ¹H signal of CHCl₃ at 7.20 ppm.

The epoxides are quantified by integrating the signal at 3.1 ppm corresponding to the —CH— of the intact epoxide, 1 proton being taking into account.

### 4. Analysis by NMR of the Coupling of the Drafted Copolymers Formed (TPEs)

a) DOSY NMR

The presence of diene elastomer-PA grafted copolymer is determined by two-dimensional DOSY (Diffusion Ordered SpetroscopY) diffusion experiments in a solvent for the diene elastomer and for the polyamide, for example a deuterated chloroform/m-cresol blend.

The samples (approximately 20 mg of TPE) are dissolved in 1 ml of CDCl₃/m-cresol (80/20 weight/weight) mixture and introduced into a 5 mm NMR tube. The spectra are recorded using an Avance III HD 500 MHz Bruker spectrometer equipped with a BBFO 1H-X 5 mm Z_GRD probe.

The ¹H NMR experiment used for the identification of the entities is a simple pulse sequence with a tip angle at 30° and a repetition time of 5 seconds between each acquisition. 64 accumulations are recorded at ambient temperature. The spectra are calibrated with regard to the ¹H signal of CHCl₃ at 7.20 ppm.

The DOSY NMR experiment used is a sequence of STE (Stimulated Echo) type according to the reference Journal of Magnetic Resonance, Vol. 115, pp. 260-264, 1995, with a repetition time of 10 seconds between each acquisition, a diffusion time of 200 ms and a duration of the pulse gradients of 4 ms. 16 accumulations and 64 lines are recorded at ambient temperature.

In order to determine if the grafting of the diene elastomer and PA matrices has operated, DOSY experiments are carried out according to the reference Polym. Chem., 3 (2012) 2006-2010.

The DOSY experiment results in a two-dimensional plot being obtained. After a treatment of the indirect dimension F1, corresponding to the decrease in the ¹H NMR signal as a function of the applied gradient strength, via an Inverse Laplace Transform (ILT) according to the reference Anal. Chem., 70 (1998), 2146-2148, the average diffusion coefficient of the entity under consideration is determined.

The entities present in solution are distinguished via the diffusion coefficients. Two entities with an identical diffusion coefficient are regarded as linked. Under these analytical conditions, it is confirmed beforehand that the diffusion coefficients of the entities, taken independently of one another, are sufficiently differentiated to be observed.

The proton NMR signals followed for the determination of the diffusion coefficients are given below:
Resonance line 1, δ ¹H=5.35 ppm for the —CH═CH— unit of the 1,4-PB
Resonance line 2, δ ¹H=4.92 ppm for the —CH═CH₂ unit of the 1,2-PB
Resonance line 3, δ ¹H=3.12 ppm for the —CH₂—N— unit of the PA

It should be noted that the diffusion coefficient value is dependent on the temperature, on the viscosity and on the concentration. The values of the diffusion coefficients are thus to be compared for the analysis of one and the same tube and cannot under any circumstances be compared with another preparation.
b) Quantification of the Open Epoxide Functional Groups as Carried Out in the Examples (HR-MAS NMR)

The amount of the total and intact epoxide functional groups (unreacted during the extrusion) is determined by HR-MAS (High Resolution—Magic Angle Spinning)¹H NMR in a medium swollen in deuterated chloroform. The samples (approximately 10 mg of elastomer) are introduced into a 92 μl rotor containing CDCl₃. The spectra are recorded on an Avance III HD 500 MHz Bruker spectrometer equipped with a ¹H/¹³C HRMAS Z-GRD 4 mm dual probe.

The quantitative ¹H NMR experiment uses a simple pulse sequence with a tip angle at 30° and a repetition time of 5 seconds between each acquisition, with a rotation of 5 kHz applied to the rotor. 128 accumulations are carried out at ambient temperature. The spectra are calibrated with regard to the ¹H signal of CDCl₃ at 7.20 ppm.

The intact epoxides are quantified by integrating the signal at 3.1 ppm corresponding to the —CH— of the intact epoxide triangle, 1 proton being taken into account. The total epoxides (intact+reacted) are quantified by integrating the signal at 0 ppm corresponding to the protons of the —Si—CH₃ portions of the glycidyl unit, their number being taken into account, 12 protons in the case of a functionalization carried out with 3-(glycidoxy)propyl-1,1,3,3-tetramethyldisiloxane.

### 4. DSC (Differential Scanning Calorimetry)

Standard ISO 11357-3:2011 is used to determine the melting point and the enthalpy of fusion of the polymers and mixtures used by differential scanning calorimetry (DSC). The reference enthalpy of PA11 is 189.05 J/g (according to Zhang et al., Macromolecules, Vol. 33, No. 16, 2000). The TPE copolymers or the SBR/PA mixture (control) obtained were analysed by DSC on a DSC 1 device of the Mettler Toledo trademark.

### 5. Mechanical Tests

a) Mooney Viscosity

The Mooney viscosity ML(1+4) at 100° C. is measured according to Standard ASTM D-1646 with an oscillating consistometer. The Mooney viscosity is measured according to the following principle: the sample, analysed in the raw state (i.e., before curing), is moulded (shaped) in a cylindrical chamber heated to a given temperature (for example 100° C.). After preheating for one minute, the rotor rotates within the test specimen at 2 revolutions/minute and the working torque for maintaining this movement is measured after rotating for 4 minutes.
b) Tensile Experiments

The breaking stress (MPa) and the elongation at break (%) are measured by tensile tests according to French Standard NF T 46-002 of September 1988. All these tensile measurements are carried out under standard conditions of temperature (23±2° C.) and hygrometry (50±5% relative humidity), according to French Standard NF T 40-101 (December 1979). The measurements are carried out on H2 test specimens at a pull rate of 500 mm/min. The strain is measured by following the displacement of the crosshead. The “nominal” secant moduli (or apparent stresses, in MPa) at 10% elongation (“MA10”) and at 100% elongation (“MA100”) are calculated from the measurements of stresses and elongation.

### Example 1: EBR/PA Block Copolymers of Comb Structure

The diene elastomer is a copolymer of 1,3-diene units and of ethylene units, prepared in accordance with the process described in Patent EP 1 954 705 B1, modified with 3-(glycidoxy)propyl-1,1,3,3-tetramethyldisiloxane in order to obtain pendant epoxide functional groups. The hydrosilylation process is as described in the text of Patent Application WO 2015/091020. The properties of this elastomer are given in the following table:

TABLE 1
Elastomer A: before modification by hydrosilylation
(before functionalization)
MICROSTRUCTURE

| | |
|---|---|
| Mol % ethylene | 68.0% |
| Mol % 1,2-PB | 8.4% |
| Mol % 1,4-PB | 13.4% |
| Mol % rings | 10.2% |

SEC

| | |
|---|---|
| Mn (g/mol) | 164 000 |
| Polydispersity index | 1.7 |

Viscosity

| | |
|---|---|
| Mooney viscosity ML 1 + 4 | 32 |

Elastomer B: after modification by hydrosilylation
(after functionalization)
Functionality

| | |
|---|---|
| epoxide (¹H NMR) | 8.8 mol % |

The chain-end amine/carboxylic acid difunctional polyamide 11 (PA11) is synthesized as described below:

20.0 g (i.e., 99 mmol) of 11-aminoundecanoic acid are heated in a 250 ml reactor under a stream of nitrogen at an oil bath temperature of 250° C. for 3 hours 20 minutes and with mechanical stirring at 50 rev/min. The vacuum is then created using a vacuum pump in place of the nitrogen. A vacuum of 0.5-0.6 mbar is achieved during this stage. The water given off during the reaction is evaporated. After 1 hour 30 minutes, the vacuum pump is disconnected from the reactor and a stream of nitrogen is started up. 11 g of polyamide are recovered with a yield of 55%.

A polyamide having the following properties is obtained.

TABLE 2

| Mn | Melting point | Enthalpy of fusion |
|---|---|---|
| (g/mol) | (DSC, ° C.) | (J/g) |
| 11 500 | 187 | 77.2 |

### Extrusion

The TPE copolymers are prepared by extrusion. The introduction of the elastomer B described above into a microextruder (DSM Xplore) heated to the temperature shown in Table 3 is carried out at the same time as that of the polyamide (PA11). The rotational speed of the screws is 100 revolutions per minute. This microextruder contains a loop for recirculation of the molten substance, in order to adjust the residence time. The residence time is set at 20 min maximum in order to make possible the grafting of the polyamide to the elastomer B. The volume of the extruder is set at 7 cm³ filled with 7 g of substance in total.

The percentages by weight of elastomer and of PA11 introduced into the extruder are given in the following table:

TABLE 3

| | Controls | | Invention | | | Comparative |
|---|---|---|---|---|---|---|
| | ML0 | ML1 | ML2 | ML3 | ML4 | ML5 |
| Elastomer A: Non-functionalized | 100 | 90 | | | | |
| EBR (% by weight) | | | | | | |
| Elastomer B: Epoxide- | | | 90 | 80 | 70 | 60 |
| functionalized EBR (% by | | | | | | |
| weight) | | | | | | |
| PA11 (% by weight) | | 10 | 10 | 20 | 30 | 40 |
| Temperature (° C.) | 220 | 220 | 220 | 220 | 220 | 220 |
| Screw rotational speed (rpm) | 100 | 100 | 100 | 100 | 100 | 100 |

DOSY NMR is used to demonstrate the grafting. The analysis of the decrease in the DOSY NMR signals makes it possible to obtain the diffusion coefficient D, expressed in μm²·s⁻¹, of each of the entities present (via their characteristic signals mentioned above).

The sample ML1 is a non-reactive control mixture containing the elastomer A (non-functional EBR) and PA11:

TABLE 4
Diffusion coefficients determined by DOSY NMR for ML1

| | D1 |
|---|---|
| Resonance line | (μm² · s⁻¹) |
| 1 (1,4-PB) | 12 |
| 2 (1,2-PB) | 12 |
| 3 (PA) | 23 |

The sample ML2 is a mixture containing the elastomer B (epoxide-functionalized EBR) and PA11:

TABLE 5
Diffusion coefficients determined by DOSY NMR for ML2

| | D1 | D2 |
|---|---|---|
| Resonance line | (μm² · s⁻¹) | (μm² · s⁻¹) |
| 1 (1,4-PB) | 5 | 27 |
| 2 (1,2-PB) | 6 | 27 |
| 3 (PA) | 3 | 47 |

The unreactive ML1 exhibits two diffusion coefficients, the first corresponding to the elastomer A at approximately 23 μm²·s⁻¹ and the second at approximately 12 μm²/s⁻¹ for the free PA.

As regards ML2, three diffusion coefficients are observed: the two diffusion coefficients of the free entities at 27 μm²/s⁻¹ for the ungrafted elastomer B and at 47 μm²/s⁻¹ for the ungrafted polyamide; and a third diffusion coefficient corresponding to an entity having a greater hydrodynamic volume, the value lying between 3 and 5 μm²/s⁻¹. The observation of this third coefficient, common to the PA units and to the diene elastomer B, makes it possible to conclude that an elastomer B/polyamide grafted copolymer is present.

The mechanical properties at large strains are measured and given in the following table:

TABLE 6

| | | Elongation | | |
|---|---|---|---|---|
| | Breaking stress | at break | MA10 | MA100 |
| | (MPa) | (%) | (MPa) | (MPa) |
| ML0 control | 0.5 | 1320 | 1.0 | 0.3 |
| ML1 control | 0.9 | 210 | 3.1 | 0.8 |
| ML2 invention | 0.3 | 290 | 1.0 | 0.3 |
| ML3 invention | 1.1 | 155 | 2.3 | 1.1 |
| ML4 invention | 4.3 | 100 | 7.0 | 4.4 |
| ML5 comparative | 5.6 | 45 | 29.9 | |

A reinforcing (increase in the secant moduli MA10 and MA100) of the materials proportional to the amount of PA introduced into the extruder is observed.

### Example 2: SBR/PA11 Block Copolymers of Comb Structure

The diene elastomers C, D and E are copolymers of 1,3-diene units and of styrene units modified with 3-(glycidoxy)propyl-1,1,3,3-tetramethyldisiloxane in order to obtain pendant epoxide functional groups. The hydrosilylation process is as described in the text of Patent Application WO 2015/091020. The percentage of grafted epoxide functional groups varies from 1.2% to 9.2%.

The elastomer F is a copolymer of 1,3-diene units and of styrene units modified by epoxidation with a peracid in order to form 9.3 molar % of epoxide functional groups disubstituted in the chain, as described in Polymer Science, Ser. B, 2013, Vol. 55, Nos. 5-6, pp. 349-354. Thus, the epoxide functional groups are not pendant.

The properties of these elastomers are given in the following table:

TABLE 7

| | Mn | Mw | | 1,4-PB | 1,2-PB | PS | Epoxide |
|---|---|---|---|---|---|---|---|
| | (g/mol) | (g/mol) | PI | (% by weight) | (% by weight) | (% by weight) | (mol %) |
| Elastomer C | 214 600 | 240 600 | 1.1 | 65.9% | 15.6% | 18.5% | 9.2% |
| Elastomer D | 191 000 | 215 000 | 1.1 | 63.4% | 18.8% | 17.8% | 2.2% |
| Elastomer E | 183 700 | 202 300 | 1.1 | 63.4% | 19.0% | 17.6% | 1.2% |
| Elastomer F | 181 000 | 350 000 | 1.9 | 43.9% | 29.0% | 27.1% | 9.3% |

Stiff grafts: the same chain-end amine/carboxylic acid difunctional polyamide 11 (PA11) as in Example 1 is used.

### Extrusion

The TPE copolymers are prepared by introduction of the functionalized elastomers described above in Table 7 into a microextruder (DSM Xplore) heated to the temperature shown in Table 8 and polyamide (PA11) at the same time. The rotational speed of the screws is 100 revolutions per minute. This microextruder contains a loop for recirculation of the molten substance, in order to adjust the residence time. The residence time is set at 20 min maximum. The volume of the extruder is set at 7 cm³ filled with 7 g of substance in total.

The percentages by weight of the elastomers C, D and E and of PA11 introduced into the extruder are given in the following table:

TABLE 8

| | Control | Invention | | | | Comparative |
|---|---|---|---|---|---|---|
| | ML7 | ML8 | ML9 | ML10 | ML11 | ML12 |
| Elastomer C (% by | 100 | 90 | 80 | | | |
| weight) | | | | | | |
| Elastomer D (% by | | | | 80 | | |
| weight) | | | | | | |
| Elastomer E (% by | | | | | 80 | |
| weight) | | | | | | |
| Elastomer F (% by | | | | | | 80 |
| weight) | | | | | | |
| PA11 (% by weight) | 0 | 10 | 20 | 20 | 20 | 20 |
| Temperature (° C.) | 220 | 220 | 220 | 220 | 120 | 220 |
| Screw rotational speed | 100 | 100 | 100 | 100 | 100 | 100 |
| (rpm) | | | | | | |

The NMR analysis makes it possible to quantify the epoxide functional groups opened during the extrusion:

TABLE 9
Content of open epoxide functional groups, determined by NMR

| | Open epoxides/SBR | Intact epoxides/SBR |
|---|---|---|
| | (mol %) | (mol %) |
| ML7 | | 9.2 |
| ML8 | 4.3 | 4.9 |

The PA-free ML7 (control) does not exhibit open epoxide functional groups, whereas ML8, which is reactive with PA, exhibits approximately 4 molar % of epoxide functional groups opened during the reaction with the PA.

The mechanical properties at large strains are measured and given in the following table:

TABLE 10

| | | | | | % increase in |
|---|---|---|---|---|---|
| | Maximum | Elongation | | | MA100 with |
| | stress | at break | MA10 | MA100 | respect to the |
| | (MPa) | (%) | (MPa) | (MPa) | control ML7 |
| ML7 | 0.1 | 1000 | 0.7 | 0.1 | 0% |
| ML8 | 0.2 | 450 | 0.9 | 0.2 | 100% |
| ML9 | 0.7 | 180 | 1.8 | 0.6 | 500% |
| ML10 | 3.8 | 180 | 3.3 | 2.5 | 2400% |
| ML11 | 1.9 | 230 | 3.4 | 1.4 | 1300% |

A reinforcing (increase in MA10 and MA100) of the materials ML7, ML8 and ML9 proportional to the amount of PA introduced into the extruder is observed.

Between the mixtures ML9, ML10 and ML11, the stiffness, maximum stress and elongation at break compromise as a function of the amount of epoxide functional groups along the SBR chain is better with the elastomer D with 2.2 mol % of epoxide functional groups.

ML9, ML10 and ML11, comprising 20% by weight of PA11, i.e. 25 phr of PA11, exhibit an increase in modulus of 500% to 2500%. In Patent EP 0 358 591, the authors show an increase in stiffness of 129% to 358% by adding 25 phr of Nylon to an epoxide natural rubber according to the type of Nylon used.

The analysis of the decrease in the signals makes it possible to obtain the diffusion coefficient D, expressed in μm²·s⁻¹, of each of the entities present (via their characteristic signals mentioned above).

The sample ML12 is a control mixture containing the elastomer F (SBR epoxide-functional in the chain) and PA11:

TABLE 11
Diffusion coefficients determined by DOSY NMR for ML12

| | D1 |
|---|---|
| Resonance line | (μm² · s⁻¹) |
| 1 (1,4-PB) | 60 |
| 2 (1,2-PB) | 60 |
| 3 (PA) | 500 |

As regards ML12, only 2 populations of diffusion coefficients are observed: the diffusion coefficients at 60 μm²/s⁻¹ for the ungrafted elastomer F and at 500 μm²/s⁻¹ for the ungrafted polyamide. There is no third diffusion coefficient, which would have had to be located between 3 and 5 μm²/s⁻¹ if the elastomer F had been grafted with the polyamide. Under the operating conditions, the epoxide functional groups of the elastomer F, which are in the main chain, are not sufficiently reactive to make possible the grafting of the polyamide.

1. A process for the preparation of a polydiene/polyamide block thermoplastic elastomer (TPE) copolymer of comb structure, the percentage by weight of polyamide of which is between 10% and 35% by weight, with respect to the weight of the copolymer, comprising the reaction, in an extruder, of a polyamide and of a diene elastomer functionalized by at least one pendant epoxide functional group along the main chain, the said diene elastomer corresponding to one of the following categories:
(a) any homopolymer obtained by polymerization of a conjugated diene monomer having from 4 to 12 carbon atoms;
(b) any copolymer obtained by copolymerization of one or more conjugated dienes having from 4 to 12 carbon atoms with one another or with one or more ethylenically unsaturated monomers;
(c) any homopolymer obtained by polymerization of a non-conjugated diene monomer having from 5 to 12 carbon atoms;
(d) ny copolymer obtained by copolymerization of one or more non-conjugated dienes having from 5 to 12 carbon atoms with one another or with one or more ethylenically unsaturated monomers, the copolymer comprising less than 40% by weight of constitutional units resulting from one or more ethylenically unsaturated monomers;
(e) natural rubber;
(f) a mixture of several of the elastomers defined in (a) to (e) with one another.

2. A process according to claim 1, wherein the epoxide functional group is monosubstituted.

3. A process according to claim 1, wherein the process comprises the following stages:
a) introduction, into an extruder, of the polyamide and of the said functionalized elastomer;
b) mixing of the components introduced in stage a) and heat treatment at a temperature greater than the melting point of the polyamide; then
c) recovery of the polydiene/polyamide block thermoplastic elastomer copolymer of comb structure at the outlet of the extruder.

4. A process according to claim 1, wherein the percentage by weight of polymer introduced varies from 10% to 35% by weight, with respect to the total weight of functionalized diene elastomer introduced and of polyamide introduced.

5. A process according to claim 1, wherein stage b) is carried out at a temperature ranging from 170° C. to 230° C.

6. A process according to claim 1, wherein the duration of stage b) is less than 30 minutes.

7. A process according to claim 1, wherein the process is carried out in bulk.

8. A process according to claim 1, wherein the process is a continuous process.

9. A process according to claim 9, wherein the number-average molar mass, Mn, of the functionalized diene elastomer introduced in stage a) varies from 50 000 g/mol to 500 000 g/mol.

10. A process according to claim 1, wherein the diene elastomer is chosen from polybutadienes (BRs), synthetic polyisoprenes (IRs), natural rubber (NR), butadiene copolymers, isoprene copolymers, ethylene/conjugated diene copolymers, and the mixtures of these polymers.

11. A process according to claim 1, wherein, in the polydiene/polyamide block TPE of comb structure, the percentage by weight of polyamide varies from 15% to 35% by weight, with respect to the weight of the TPE.

12. A process according to claim 1, wherein the polydiene/polyamide block TPE of comb structure has a number-average molar mass, Mn, ranging from 50 000 g/mol to 500 000 g/mol.

13. A polydiene/polyamide block thermoplastic elastomer (TPE) copolymer of comb structure comprising units bearing a pendant polyamide along the chain which is bonded to the latter via a group resulting from the reaction, with a pendant epoxide functional group, of an amine or acid functional group of the polyamide, the said polydiene corresponding to one of the following categories:
(a) any homopolymer obtained by polymerization of a conjugated diene monomer having from 4 to 12 carbon atoms;
(b) any copolymer obtained by copolymerization of one or more conjugated dienes having from 4 to 12 carbon atoms with one another or with one or more ethylenically unsaturated monomers;
(c) any homopolymer obtained by polymerization of a non-conjugated diene monomer having from 5 to 12 carbon atoms;
(d) ny copolymer obtained by copolymerization of one or more non-conjugated dienes having from 5 to 12 carbon atoms with one another or with one or more ethylenically unsaturated monomers, the copolymer comprising less than 40% by weight of constitutional units resulting from one or more ethylenically unsaturated monomers;
(e) natural rubber;
(f) a mixture of several of the elastomers defined in (a) to (e) with one another.

14. A thermoplastic elastomer (TPE) copolymer according to claim 13, the percentage by weight of polyamide of which is between 10% and 35% by weight, with respect to the weight of the TPE.

15. A rubber composition comprising at least one polydiene/polyamide block thermoplastic elastomer (TPE) copolymer of comb structure according to claim 13 or a polydiene/polyamide block thermoplastic elastomer (TPE) copolymer of comb structure obtained by the process according to claim 1.

16. A tire comprising a rubber composition according to claim 15.
